(19) United States
(12) Patent Application Publication
(10) Pub. No.: US 2007/0114171 A1
(43) Pub. Date: May 24, 2007

(54) Composite filtering mesh, a sand control sleeve and a sand control screen pipe with the composite filtering mesh

(76) Inventors: Jichu Chen, Beijing (CN); Chunhong Huang, Beijing (CN)

Correspondence Address: J C PATENTS, INC., 4 VENTURE, SUITE 250, IRVINE, CA, 92618, US

(21) Appl. No.: 10/510,195

(22) PCT Filed: Feb. 10, 2003
(86) PCT No.: PCT/CN03/00129

§ 371 Date: May 12, 2005

(30) Foreign Application Priority Data
Apr. 1, 2002 (CN) 02209128.9

(51) Int. Cl. B01D 29/00

(52) U.S. Cl. 210/489

(57) ABSTRACT

The present invention discloses a filtering mesh for an oil well, a sand control sleeve and a sand control screen pipe using the filtering mesh. The filtering mesh at least comprises a bottom diffusion mesh (20) and one or more twill weave meshes (21) fixed on the bottom diffusion mesh (20); one or more twill weave meshes (21) are applied in filtrating solid particulates in a stratum fluid, and the bottom diffusion mesh (20) is applied in diffusing the filtrated fluid. The bottom diffusion mesh (20) is a woven mesh or a punching steel plate mesh with 5-50 meshes; the aperture of the twill weave mesh (21) is 40-400 micron. The present invention also relates to a sand control sleeve formed of the filtering mesh, a tubular inner protective shroud (19) and a supporting ring (15). This invention further relates to a sand control screen pipe formed of the filtering mesh, a multi-holes base pipe (1), a tubular inner protective shroud (19), an outer protective shroud (3) and a supporting ring (15).

### FIELD OF THE INVENTION

The present invention relates to a sand control fluid filter, particularly a metallic composite filtering mesh, which can be used in the exploitation of petroleum and natural gas well, and an under-well sand control screen pipe with the filtering mesh preventing stratum sand's entry into the well bore.

### BACKGROUND OF THE INVENTION

During the exploitation of petroleum and natural gas, a portion of loose sand forming the stratum would enter into the petroleum well bore accompanied by the movement of the flowing petroleum and gas, thereby producing sand in the petroleum and gas well. Sand in petroleum layer and gas layer will cause great damage to petroleum layer, gas layer, protective tube, under-well equipment and tools. The slight effect of that damage may decrease the production and increase the under-well workload, thereby increasing the exploitation cost; the severe damage may result in the stop of production. Sand control screen pipes are mechanical filtering devices used for preventing stratum sand from entering into the well sleeve and controlling sand brought out from the stratum. Presently, the mechanical sand control screen pipes mainly include: seam welded screen, wire-wrapped screen, wire woven sand control screen and sintered filter sand control screen, etc.

The main disadvantages of the seam welded screen and the wire-wrapped screen are: small seepage area (generally, filtering area is only 3-5 percent of the surface area of the screen) and easy blocking, thereby impacting production of petroleum well and gas well.

The main disadvantage of the wire woven sand screen is that filtering holes are unstable and not reliable which would easily result in the failure of sand control.

The sintered filter sand screen can be sintered by metal powder or layers of metal mesh, or made into a sand control layer by sintering metal mesh with metal powder. Although this kind of sintered filter sand screen is an effective sand screen, its complicated manufacturing technique increases the producing difficulty and the cost, and the anticorrosive ability of the metal wire will be descended after it is sintered by heating.

With the development of petroleum prospecting technology and the sea oil and gas resources, wells with complicated structures such as direction well, horizontal well, clustered well and embranchment well become increasingly ordinary. Therefore, the sand control screen pipe should meet the following technical requirements:
1. Characteristic of thin wall, large internal diameter, little resistance and high yield.
2. Ability of bearing strong curving, shaping and radial distortion to effectively control the sand.
3. High reliability of sand controlling and no sand leaking holes; high strength of meshes; longer in length for the pipe sleeve and fewer joints.
4. Large seeping flow area and less flow resistance.
5. Anticorrosive ability of acid, salt and CO₂.

To meet the requirements of sand controlling of modern oil-gas wells, currently, the prior arts of Dutch Twill and the metallic fiber sintered materials have been widely adopted as filtration materials to construct sand control screen, such as the technical contents disclosed in U.S. Pat. No. 5,611,399 and Chinese Patent No. 94192239.1. According to the disclosure in U.S. Pat. No. 5,611,399, the sand control screen consists of two filtration layers, wherein the outer layer is a metal fine screen pipe and the inner layer is a wound wire layer. The metal fine screen has longitudinal seams connected with each other by overlapped joints. The wound wire layer supports the metal fine screen and acts as the second sand control mesh layer. But, the above metal fine screen pipe has lower joint intension at the longitudinal seam and weak resistance against the inner pressure, and is prone to be damaged which results in the failure of sand controlling. The wound wire layer demands high precision in seam width, which needs costly dedicated equipment. As a result, the cost of manufacturing the sand control screen pipe is very high.

The sand control screen pipe disclosed in Chinese Patent No. 94192239.1 is formed of layers of sintered porous medium. Manufacturing cost of such sand control screen pipe is still very high because of its complicated sintering techniques in vacuum. In the case of using multiple layers of sand control materials for the sand control screen pipe, the layers of sand control mesh cannot be welded into a sleeve in advance due to the difficulty of the craftwork and technique of fixing the sand control mesh. Actually, layers of the sand control meshes will be assembled after intension and light leakage inspection and could only be fixed layer by layer on the multi-holes base pipe. However, there will be hidden quality problem because of the inconvenience of inspecting the fixing quality.

### SUMMARY OF THE INVENTION

One objective of the present invention is to provide a composite metallic filtering mesh with layers of metal composite filtering meshes, which can accurately control the filtration precise and have large seeping flow area and less flow resistance as well as even filtering holes. The composite metallic filtering mesh can stabilize the filtering holes when the multi-holes base pipe is distorted by bending.

Another objective of the invention is to provide a sand control sleeve with said composite metallic filtering mesh. The sand control sleeve has the advantage of high intension, excellent anti-corrosive ability and conveniently connecting with relative pipes. Therefore its mechanical technique is simple and its manufacturing cost is low.

A further objective of the present invention is to provide a sand control screen pipe with said composite metallic filtering mesh. The sand control screen pipe has the advantage of high intension, excellent anticorrosive ability and glidingly entering and leaving the well so that it will have efficient and longer service lifetime with reliable sand control and anti blocking capability.

The present invention provides a composite metallic filtering mesh, at least comprising: a bottom diffusion mesh and one or more twill weave meshes; one or more twill weave meshes fixed on an outer surface of the bottom diffusion mesh, wherein one or more twill weave meshes are applied in filtrating solid particulates in a fluid and the bottom diffusion mesh is applied in diffusing the filtrated fluid. Thus, an essential mesh was formed by fixing the above mentioned two meshes together.

The twill weave meshes are two or more layers; one or more inter-layer diffusion meshes are fixed between two layers of the twill weave meshes and one or more inter-layer diffusion meshes diffuse the filtrated fluid between the layers so that it enhances the filtration effect and ensures the filtered fluid flowing smoothly.

The inter-layer diffusion mesh is fixed on an outer surface of the twill weave mesh in order to fully diffuse the fluid between the twill weave mesh and its external device.

A metal fiber layer is fixed on the outer surface of the twill weave mesh; the metal fiber layer is formed by weaving metal wires so that the filtrated fluid is diffused more adequately.

The metal fiber layer is fixed between the inter-layer diffusion meshes to ensure the smooth flowing of the filtered fluid.

The metal fiber layer is made of wires with 0.05-0.30 mm in diameter and the thickness of the metal fiber layer is 3-30 mm. The bottom diffusion mesh is a woven mesh or a punching steel plate mesh with 5-50 meshes. The aperture of the twill weave mesh is 40-400 micron. The inter-layer diffusion mesh is a woven mesh with 10-60 meshes.

A sand control sleeve with the composite metallic filtering mesh comprises: a mesh sleeve formed of the composite metallic filtering mesh, a tubular inner protective shroud with through-bores distributed on its surface, and supporting rings; the mesh sleeve being fixed around the outer side of the tubular inner protective shroud; the supporting rings being respectively wrapping-set and fixed at connections of the outer sides of both ends of the tubular inner protective shroud and ends of the mesh sleeve. Therefore forms a tubular filtration device which can filter the fluid.

Ring hoops for fixing the mesh sleeve are fixed respectively on the outer sides of both ends of the mesh sleeve, which make the sleeve formed of the composite metallic filtering mesh stable. To prevent the damage of the sleeve, an outer protective shroud is fixed on the surface of the mesh sleeve; through-bores are opened and distributed on the surface of the outer protective shroud.

A sand control screen pipe with the sand control sleeve is composed of the sand control sleeve and a pipe body lengthen-fixed at each end of the sand control sleeve; or is composed of the sand control sleeve and a pipe body with through-bores on its surface, and the sand control sleeve ring-fixes on the pipe body and completely covers all through-bores on the pipe body; a connecting mechanism is provided on both ends of the sand control screen pipe for connecting with other assemblies. Therefore, makes two kinds of sand control screen pipe: a sand control screen pipe with a pipe body fixing at both ends of the sand control sleeve respectively; or a sand control screen pipe with the sand control sleeve fixing on the outer surface of an independent pipe body with through-bores; the two kinds of sand control screen can be connected with other assemblies by binding mechanism provided on both ends.

Two or more supporting blocks are provided on the outer surface of the pipe body in order to make the sand control screen pipe be placed in the middle center while dropping down into the well.

A sand control screen pipe with the composite metallic filtering mesh comprises: a multi-holes base pipe, an inner protective shroud and a plurality of supporting rings of the inner protective shroud; wherein the composite metallic filtering mesh is fixed on the inner side of the multi-holes base pipe, and completely covers all through holes on the multi-holes base pipe; the inner protective shroud has petroleum-seeping holes, and is fixed on the inner side of the composite metallic filtering mesh and completely covers the composite metallic filtering mesh; the supporting ring of the inner protective shroud is fixed on both ends of the inner side of hole area of the multi-holes base pipe; the two ends of the inner protective shroud along the axial direction of the multi-holes base pipe are fixed respectively on the supporting ring. Such setting provides the composite metallic filtering mesh with protection by the multi-holes base pipe, and the multi-holes base pipe has even surface to be easily moved in the well.

An inner pipe is fixed on the inner side of the inner protective shroud. And parts for connecting with other assemblies are set on both ends of the multi-holes base pipe.

The composite metallic filtering mesh of the present invention has many metal composite metallic filtering layers. It can accurately control the filtration precise and have large seeping flow area, less flow resistance as well as even filtering holes. The composite metallic filtering mesh can stabilize the filtering holes when the multi-holes base pipe is distorted by bending. The sand control screen pipe and composite metallic sand control sleeve with the composite metallic filtering mesh have the advantage of high intension, excellent anticorrosion, reliable sand controlling and strong anti-blocking ability, so that it will give efficient and longer service lifetime as well as simple mechanical technique and lower manufacturing cost.

### BRIEF DESCRIPTION OF THE DRAWINGS

FIG. 1 is a schematic diagram showing a structure of filtration layer of the composite metallic filtering mesh according to the present invention;

FIG. 2 is a schematic diagram showing another structure of filtration layer of the composite metallic filtering mesh according to the present invention;

FIG. 3 is a schematic diagram showing another structure of filtration layer of the composite metallic filtering mesh according to the present invention;

FIG. 4 is a schematic diagram showing another structure of filtration layer of the composite metallic filtering mesh according to the present invention;

FIG. 5 is a schematic diagram showing the composite metal sand control sleeve composed of the composite metallic filtering mesh according to the present invention;

FIG. 6 is a schematic diagram showing an embodiment of the composite metal sand control screen pipe according to the present invention;

FIG. 7 is a partially enlarged schematic diagram of section B of FIG. 6;

FIG. 8 is a schematic diagram showing another embodiment of the composite metal sand control screen pipe according to the present invention.

### DETAILED DESCRIPTION OF THE PREFERRED EMBODIMENTS

The present invention is described in detail with reference to the accompanying drawings and the embodiments.

### Embodiment 1

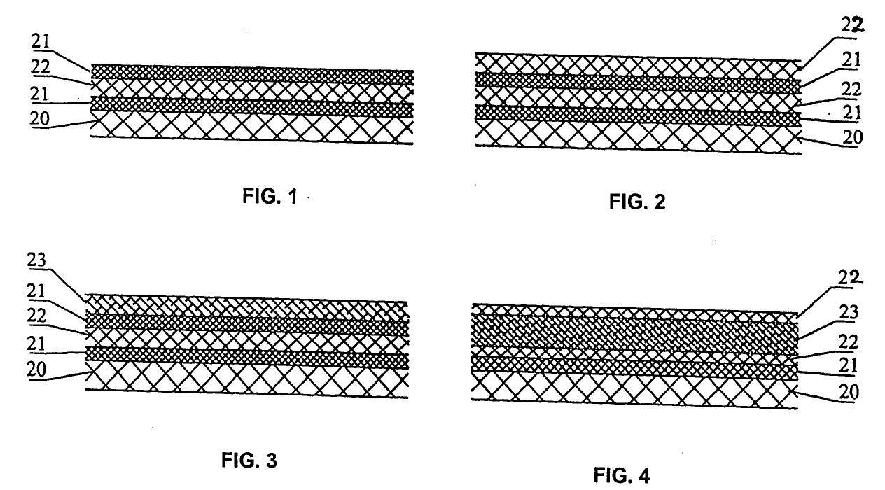

Now referring to FIG. 1, a composite metallic filtering mesh of the present invention at least comprises an bottom diffusion mesh 20, one or more twill weave meshes 21, an inter-layer diffusion mesh 22 between the two twill weave meshes 21; the bottom diffusion mesh 20, one or more twill weave meshes 21 and the inter-layer diffusion mesh 22 are superposed in turn and connected firmly to form the composite metallic filtering mesh.

### Embodiment 2

Now referring to FIG. 2, another composite metallic filtering mesh of the present invention at least comprises an bottom diffusion mesh 20, one or more twill weave meshes 21, an inter-layer diffusion mesh 22 between the two twill weave meshes 21; an inter-layer diffusion mesh 22 provided above the outer twill weave mesh 21, forming the composite filtering mesh.

### Embodiment 3

Now referring to FIG. 3, yet another composite metallic filtering mesh of the present invention at least comprises an bottom diffusion mesh 20, one or more twill weave meshes 21, an inter-layer diffusion mesh 22 between the two twill weave meshes 21; a metal fiber layer 23 provided above the outmost twill weave mesh 21. And the bottom diffusion mesh 20, one or more twill weave meshes 21, the inter-layer diffusion mesh 22 and the metal fiber layer 23 are superposed in turn and connected firmly to form the composite metallic filtering mesh.

### Embodiment 4

Now referring to FIG. 4, yet another composite metallic filtering mesh of the present invention is formed of an bottom diffusion mesh 20, a twill weave mesh 21, an inter-layer diffusion mesh 22, a metal fiber layer 23 and another inter-layer diffusion mesh 22 superposed in turn and connected firmly.

The above-mentioned bottom diffusion mesh 20 is a wire woven mesh with 30 mesh square opening; the aperture of the twill weave mesh is 200 micron; the metal fiber layer is made of wires with 0.10 mm in diameter and the thickness of the metal fiber layer is 10 mm; the inter-layer diffusion mesh 22 is a kind of wire woven mesh with 30 mesh square opening.

### Embodiment 5

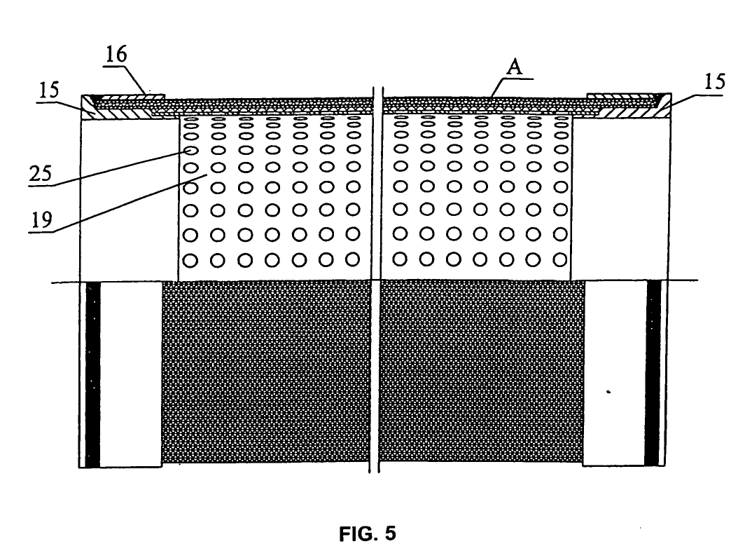

Referring to FIG. 5, a sand control sleeve with the composite metallic filtering mesh is formed of the composite metallic filtering mesh A; wherein the sand control sleeve is provided with an inner protective shroud 19 which is formed by rounding and fixing a steel sheet mesh and has densely distributed through-holes 25. The inner protective shroud 19 has a supporting ring 15 at each end, and the composite metallic filtering mesh A is wrapping-set on the outer side of the inner protective shroud 19, thus forming the sand control sleeve. The metal mesh of the metallic filtering mesh A is fixed to the ring seam of the supporting rings 15 of the sand control sleeve. A ring hoop 16 fixes the composite metallic filtering mesh at the end of the sand control sleeve.

### Embodiment 6

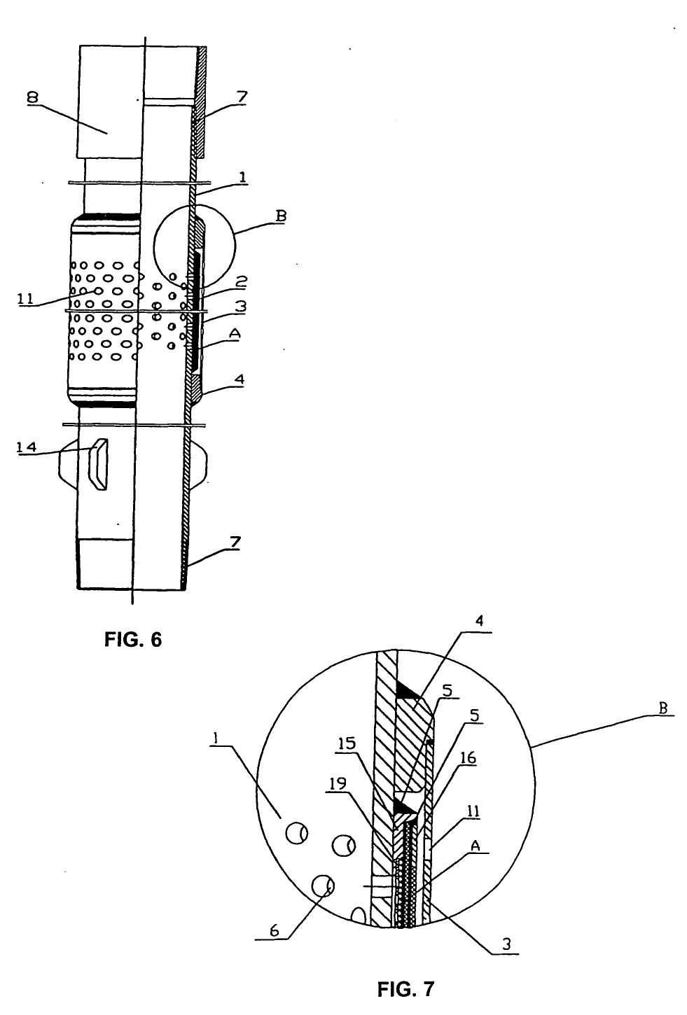

Now referring to FIGS. 6 and 7, a sand control screen pipe with the composite metallic filtering mesh is formed by fixing a multi-holes base pipe 1, a composite metallic filtering mesh A, an outer protective sleeve 3 and a supporting ring 4 to support the outer protective sleeve. The multi-holes base pipe 1 is formed with a regular sleeve or an oil pipe generally used in the oil field, and also can be formed with stainless steel oil pipe to satisfy special antisepticising demand. The multi-holes base pipe 1 has an outer screw thread 7 at each end for connecting with an oil pipe body 8. Holes 6 are equally disposed on the central section of the multi-holes base pipe 1 for the stratum fluid flowing. There is an inner protective sleeve 19 of the innermost layer of the composite metallic filtering mesh A, which is formed by rounding steel sheet with holes; the inner protective sleeve 19 is fixed to the composite metallic filtering mesh A and the supporting ring 15 at its each end. The composite metallic filtering mesh A is fixed to the outer surface of the inner protective sleeve 19, and its ends are hermetically fixed to the supporting rings 15 by ring hoops 16. The composite metallic filtering mesh A is fixed on the multi-holes base pipe 1. The supporting rings 15 and the multi-holes base pipe 1 are fixed integrally. The annular welding lines 5 functions for connecting and ends sealing. An outer protective sleeve 3 has many densely-distributed fluid holes 11, which is fixed on the outer side of the composite metallic filtering mesh A; the outer protective sleeve 3 is positioned and supported by the protective supporting rings 4. The protective supporting rings 4 and the multi-holes base pipe 1 are fixed together by each other and the outer protective sleeve 3 and protective supporting rings 4 are fixed together by each other. There can be provided A supporting block 14 is located in a suitable position on the multi-holes base pipe 1 so that the sand control screen pipe with composite metallic filtering mesh is placed in the middle center while dropping down in the well to avoid the damage of the outer protective sleeve 3.

### Embodiment 7

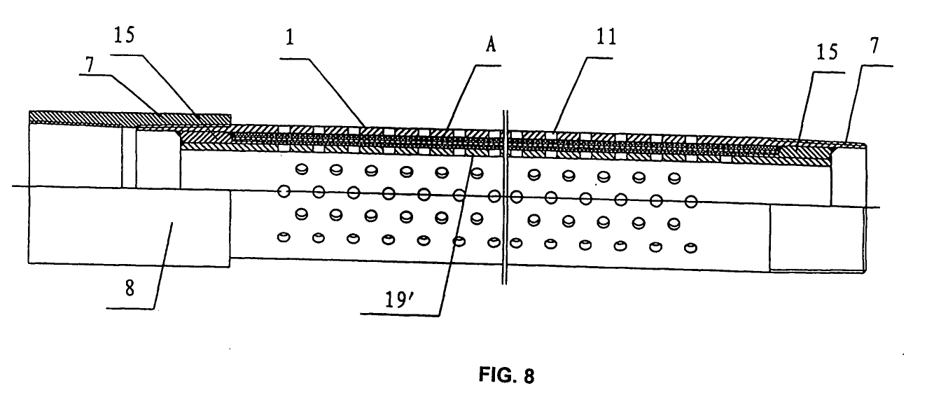

Referring to FIG. 8, another sand control screen pipe with the composite metallic filtering mesh is formed by fixing a multi-holes base pipe 1, a composite metallic filtering mesh A and supporting rings 15. The multi-holes base pipe 1 is formed with a regular sleeve or an oil pipe generally used in the oil field, and also can be formed with stainless steel oil pipe to satisfy special antisepticising demand. The multi-holes base pipe 1 has an outer screw thread 7 at each end for connecting with an oil pipe body 8. Fluid holes 11 are equally disposed on the central section of the multi-holes base pipe 1 for the stratum fluid flowing. There is an inner pipe 19′ of the innermost layer of the composite metallic filtering mesh A, which is formed by rounding steel sheet with holes; the inner pipe 19′ is fixed to the composite metallic filtering mesh A and the supporting ring 15 at its each end. The composite metallic filtering mesh A is fixed to the outer surface of the inner pipe 19′, and its ends are hermetically fixed to the supporting rings 15 directly. The composite metallic filtering mesh A is fixed on the inner surface of the multi-holes base pipe 1. The supporting rings 15 and the multi-holes base pipe 1 are fixed integrally, thus, forming a build-in sand control screen pipe with the composite metallic filtering mesh.

Finally, it should be noted that the preferred embodiments intend only to explain but not to limit the present invention. Although the present invention has been described in detail by referring to the above-mentioned embodiments, it should be appreciated that any modifications or equivalents of the invention are not departing from the principle of the present invention.

1. A composite metallic filtering mesh, at least comprising:
a bottom diffusion mesh and one or more twill weave meshes; one or more twill weave meshes fixed on an outer surface of the bottom diffusion mesh, wherein one or more twill weave meshes are applied in filtrating solid particulates in a fluid and the bottom diffusion mesh is applied in diffusing the filtrated fluid.

2. The composite metallic filtering mesh according to claim 1, wherein the twill weave meshes are two or more layers; one or more inter-layer diffusion meshes are fixed between two layers of the twill weave meshes and one or more inter-layer diffusion meshes diffuse the filtrated fluid between the layers; an inter-layer diffusion mesh is fixed on an outer surface of the twill weave mesh in order to fully diffuse the fluid between the twill weave mesh and its external device.

3-17. (canceled)

18. The composite metallic filtering mesh according to claim 2, wherein a metal fiber layer is fixed on the outer surface of the twill weave mesh or between the inter-layer diffusion meshes; the metal fiber layer is made of weaving metal wires with 0.05-0.30 mm in diameter and the thickness of the metal fiber layer is 3-30 mm.

19. The composite metallic filtering mesh according to claim 2, wherein the bottom diffusion mesh is a woven mesh or a punching steel plate mesh with 5-50 meshes; the aperture of the twill weave mesh is 40-400 micron; the inter-layer diffusion mesh is a woven mesh with 10-60 meshes.

20. A sand control screen pipe, wherein the sand control screen pipe is composed of a sand control sleeve and a pipe body lengthen-fixed at each end of the sand control sleeve; or is composed of the sand control sleeve and a pipe body with through-bores on its surface, and the sand control sleeve ring-fixes on the pipe body and completely covers all through-bores on the pipe body; a connecting mechanism is provided on both ends of the sand control screen pipe for connecting with other assemblies; the sand control sleeve with the composite metallic filtering mesh comprises a mesh sleeve formed of the composite metallic filtering mesh, a tubular inner protective shroud with through-bores distributed on its surface, and supporting rings; an outer protective shroud is fixed on the surface of the mesh sleeve; through-bores are opened and distributed on the surface of the outer protective shroud; the composite metallic filtering mesh comprises a bottom diffusion mesh and one or more twill weave meshes; one or more twill weave meshes fixed on an outer surface of the bottom diffusion mesh, wherein one or more twill weave meshes are applied in filtrating solid particulates in a fluid; the twill weave meshes are one or more layers; one or more inter-layer diffusion meshes are fixed between more than one layer of the twill weave meshes and one or more inter-layer diffusion meshes diffuse the filtrated fluid between the two layers of twill weave meshes; an inter-layer diffusion mesh is fixed on an outer surface of the twill weave mesh in order to fully diffuse the fluid between the twill weave mesh and its external device; the bottom diffusion mesh is applied in diffusing the filtrated fluid; the mesh sleeve being fixed around the outer side of the tubular inner protective shroud; the supporting rings being respectively wrapping-set and fixed at connections of the outer sides of both ends of the tubular inner protective shroud and ends of the mesh sleeve.

21. The sand control screen pipe according to claim 20, wherein a metal fiber layer is fixed on the outer surface of the twill weave mesh or between the inter-layer diffusion meshes; the metal fiber layer is made of weaving metal wires with 0.05-0.30 mm in diameter and the thickness of the metal fiber layer is 3-30 mm.

22. The sand control screen pipe according to claim 20, wherein the bottom diffusion mesh is a woven mesh or a punching steel plate mesh with 5-50 meshes; the aperture of the twill weave mesh is 40-400 micron; the inter-layer diffusion mesh is a woven mesh with 10-60 meshes.

23. The sand control screen pipe according to claim 20, wherein ring hoops for fixing the mesh sleeve are fixed respectively on the outer sides of both ends of the mesh sleeve.14, wherein two or more supporting blocks are provided on the outer surface of the pipe body in order to make the sand control screen pipe be placed in the middle center while dropping down into the well.

24. A sand control screen pipe, comprising: a composite metallic filtering mesh, a multi-holes base pipe, an inner protective shroud and a plurality of supporting rings of the inner protective shroud; wherein the composite metallic filtering mesh comprises a bottom diffusion mesh and one or more twill weave meshes; one or more twill weave meshes fixed on an outer surface of the bottom diffusion mesh, wherein one or more twill weave meshes are applied in filtrating solid particulates in a fluid; the twill weave meshes are one or more layers; one or more inter-layer diffusion meshes are fixed between more than one layer of the twill weave meshes and one or more inter-layer diffusion meshes diffuse the filtrated fluid between the two layers of twill weave meshes; an inter-layer diffusion mesh is fixed on an outer surface of the twill weave mesh in order to fully diffuse the fluid between the twill weave mesh and its external device; the bottom diffusion mesh is applied in diffusing the filtrated fluid; the composite metallic filtering mesh is fixed on the inner side of the multi-holes base pipe, and completely covers all through holes on the multi-holes base pipe; the inner protective shroud has petroleum-seeping holes, and is fixed on the inner side of the composite metallic filtering mesh and completely covers the composite metallic filtering mesh; the supporting ring of the inner protective shroud is fixed on both ends of the inner side of hole area of the multi-holes base pipe; the two ends of the inner protective shroud along the axial direction of the multi-holes base pipe are fixed respectively on the supporting ring; an inner pipe is fixed on the inner side of the inner protective shroud.

25. The sand control screen pipe according to claim 24, wherein the bottom diffusion mesh is a woven mesh or a punching steel plate mesh with 5-50 meshes; the aperture of the twill weave mesh is 40-400 micron; the inter-layer diffusion mesh is a woven mesh with 10-60 meshes; an inner pipe is fixed on the inner side of the inner protective shroud; parts for connecting with other assemblies are set on both ends of the multi-holes base pipe.
